(19) United States
(12) Patent Application Publication
(10) Pub. No.: US 2011/0117381 A1
(43) Pub. Date: May 19, 2011

(54) MILDLY ALKALINE THIN INORGANIC CORROSION PROTECTIVE COATING FOR METAL SUBSTRATES

(76) Inventors: Thomas S. Smith, II, Novi, MI (US); Jasdeep Sohi, Shelby Township, MI (US); Brian D. Bammel, Rochester Hills, MI (US); Gregory T. Donaldson, Sterling Heights, MI (US); John J. Comoford, Royal Oak, MI (US)

(21) Appl. No.: 12/993,579

(22) PCT Filed: May 19, 2009
(86) PCT No.: PCT/US09/44504

§ 371 Date: Jan. 11, 2011

Related U.S. Application Data
(62) Division of application No. 61/054,363, filed on May 19, 2008.

(51) Int. Cl. C23C 18/00; C08K 3/10; B05D 3/10; B32B 15/00

(52) U.S. Cl. 428/615; 106/1.22; 524/408; 427/383.7

(57) ABSTRACT

Disclosed is a neutral to alkaline inorganic chrome-free conversion coating composition that can be applied directly to a metal surface without a phosphatizing pre-treatment and that provides significant corrosion protection to the surface. The conversion coating composition preferably has a pH of from about 6 to 11 and more preferably from 8 to 10. The coating composition includes at least one element from group IVB of the Periodic table and at least one element from group VB of the Periodic Table. Preferably, the coating composition includes from 1 to 7% by weight of the at least one element from group IVB and from 0.20% to 2.00% by weight of the at least one element from group VB. The conversion coating composition is a dry in place coating and being chrome free it does not have the environmental issues associated with chrome-based coatings. The coating composition is very versatile and can accommodate addition of a wide variety of organic coating resins which can be added directly to the coating composition thus eliminating multistep coating processes.

### RELATED APPLICATIONS

NONE

### STATEMENT REGARDING FEDERALLY SPONSORED RESEARCH

NONE

### TECHNICAL FIELD

This invention relates generally to corrosion protection of metal substrates, more particularly to a neutral to mildly alkaline thin inorganic coating that can be applied directly to a metal substrate without pre-treatment such as a phosphatizing solution and that provides enhanced corrosion protection to the metal substrate.

### BACKGROUND OF THE INVENTION

Untreated metal surfaces are subject to corrosion which can lead to rust development, weakening, discoloration and failure of the surface. Thus metal substrates are typically treated by a variety of methods to make the surface less reactive and more corrosion resistant. In addition, metal surfaces are often subsequently coated with decorative or additional protective coatings such as resin coatings, primers, paints and other surface treatments. Often the initial treatment of the metal surface involves a metal phosphate treatment followed by a chrome-containing rinse. This treatment is effective, but undesirable because the metal phosphate and chrome-containing rinses produce waste streams that are detrimental to the environment. The cost for disposing of these waste streams also continues to increase. Typically, these treatments require quite acidic conditions and such an acidic environment is not desirable for many metal substrates. Thus, it is desirable to create treatment processes and solutions that provide enhanced corrosion protection to metal substrates without the associated waste streams of the prior solutions. In addition, it would be beneficial to develop a solution that was inorganic and that could be carried out under neutral or mildly alkaline conditions. Finally, it is desirable to provide a solution that would not prevent continued use of the other decorative surface treatments that have been used in the past.

### SUMMARY OF THE INVENTION

In general terms, this invention provides a neutral or mildly alkaline inorganic coating solution that can be applied directly to a metal surface without a phosphatizing pre-treatment and that provides significant corrosion protection. The coating solution preferably has a pH of from about 6 to 11 and more preferably from 8 to 10. The coating solution comprises a source of at least one of the group IVB transition metal elements of the Periodic Table, namely zirconium, titanium, and hafnium and a source of at least one of the group VB transition metal elements of the Periodic Table, namely vanadium, niobium, and tantalum. Preferably, the coating solution includes from 1 to 7% by weight of the group IVB element, more preferably from 2 to 5% by weight and most preferably from 3 to 5% by weight, based on the total weight of the coating solution. Preferably, the coating solution includes from 0.2 to 2.00% by weight and more preferably from 0.40% to 1.00% by weight of the group VB element, based on the total weight of the coating solution. A preferred group IVB element is zirconium, preferably supplied as ammonium zirconyl carbonate. A preferred group VB element is vanadium supplied as V₂O₅. The coating solution is a dry in place conversion coating and is also chrome free thus does not have the environmental issues associated with chrome-based coatings. The coating is very versatile because it can accommodate addition of a wide variety of organic coating resins which can be added directly to the coating solution thus eliminating multistep coating processes, the suitable resins being ones that are dispersible or soluble in the aqueous coating solution. Being a conversion coating, as the term is known in the art, components within the coating solution react with the metal substrate during the coating process to produce the final dry in place coating.

These and other features and advantages of this invention will become more apparent to those skilled in the art from the detailed description of a preferred embodiment. The drawings that accompany the detailed description are described below.

### DETAILED DESCRIPTION OF A PREFERRED EMBODIMENT

The present invention is directed toward treatment of bare metal surfaces meaning that the metal surface has not been pre-treated with any metal phosphate solutions, chrome-containing rinses, or any other passivating treatments. Metal surfaces that benefit from the process of the present invention include steel, cold rolled steel, hot rolled steel, stainless steel, aluminum, steel coated with zinc metal or zinc alloys such as electrogalvanized steel, Galvalume®, galvanneal, and hot-dipped galvanized steel.

Preferably, the metal surface has been cleaned and degreased prior to treatment according to the present invention. Cleaning of metal surfaces is well known in the art and can include mild or strongly alkaline cleaners. Examples of two alkaline cleaners include Parco® Cleaner ZX-1 and Parco® Cleaner 315 both available from Henkel Surface Technologies. Following cleaning the surface is preferably rinsed with water prior to treatment according to the present invention.

The corrosion protection coating of the present invention comprises a mixture of at least one group IVB element and at least one group VB element in deionized water at a pH of from about 6 to 11 and more preferably at a pH of from 8 to 10. It is important that the pH of the solution be kept in this range for the coating process to work. Preferably, the group IVB element is present in an amount of from about 1 to 7% by weight, more preferably from about 2 to 5% by weight and most preferably from 3 to 5% by weight of the solution based on the total weight of the solution. The coating composition can include any sub-range between 1 to 7% by weight based on the total weight. Preferably the amount of group VB element in the solution is from about 0.20 to 2.00% by weight and more preferably from about 0.40 to 1.00% by weight based on the total weight of the solution. The coating composition can include any sub-range between 0.20 to 2.00% by weight based on the total weight. Preferably the coating solution is a mixture of zirconium and vanadium. One preferred source of zirconium is ammonium zirconyl carbonate called Bacote 20® and available from MEI in Flemington N.J. According to the literature from MEI, Bacote 20® is a clear, aqueous alkaline solution of stabilized ammonium zirconium carbonate containing anionic hydroxylated zirconium polymers. It provides approximately 20% w/w of ZrO₂. It is sold as a crosslinking agent for paper and paperboard applications. The preferred group VB element is vanadium provided as V₂O₅. Optionally, the present coating can further accommodate the addition of organic coating resins of a variety of types including, by way of example only: epoxies, polyvinyl dichlorides, acrylic-based resins, methacrylate-based resins, styrene-based resins, polyurethane dispersions, and polyurethane dispersion hybrids. Examples of these resins include Carboset® CR760, Hauthane HD-2120, Hauthane L-2989, Maincote™ PR-15, Maincote™ PR-71, Avanse MV-100, Rhoplex AC 337N, and Alberdingk-Boley LV-51136 and M-2959. The coating can also accommodate addition of reducing agents for the V₂O₅ such as cysteine, Sn²⁺, ascorbic acid, or thiosuccinic acid. Optionally, one could initially start with V⁺⁴ from vanadyl sulfate or vanadyl acetylacetonate. Optionally, the coating can also include processing aids such as waxes which aid in formability of the coated substrates. Addition of these optional agents will be discussed further below.

In a first example an inorganic coating solution according to the present invention was prepared by combining 83.00% by weight deionized (DI) water with 1.00% by weight V₂O₅ and 16.00% by weight of Bacote 20®. This level of Bacote 20® provides 3.2% by weight of ZrO₂ to the solution. The solution pH was approximately 9.5. The inorganic coating was applied to a series of hot-dipped galvanized (HDG) panels known as ACT HDG panels APR 31893 and U.S. Steel Corp. (USS) Galvalume® panels using the known technique of a draw wire to apply a coating weight of 200 milligrams per square foot (200 milligrams per 929.03 square centimeters). Galvalume® is the trademark name for 55% aluminum-zinc alloy coated sheet steel. Once applied the coating was dried in place to a Peak Metal Temperature (PMT) of 210° F. (98° C.) on the test panels. The panels were then subjected to a Neutral Salt Spray (NSS) corrosion test using method ASTM B117 with multiple panels for each time point. In this testing uncoated panels of either HDG or USS Galvalume® showed 100% corrosion with in 24 hours in the NSS test. The test results for the average percent corrosion for each of the treated panels are shown below in Table 1.

TABLE 1

| | Time, hours (NSS) | | | | | | | |
|---|---|---|---|---|---|---|---|---|
| | 24 | 48 | 144 | 312 | 480 | 649 | 816 | 1008 |
| HDG | | 70.00 | | | | | | |
| USS | 0.00 | 00.00 | 0.00 | 4.00 | 13.00 | 13.00 | 22.00 | 25.00 |
| Galvalume ® | | | | | | | | |

The results demonstrate the usefulness of the coating solution prepared according to the present invention. The coating solution of the present invention was very effective on USS Galvalume® steel providing significant corrosion protection out to 1008 hours as shown. These results are in dramatic difference to uncoated USS Galvalume® which was 100% corroded within 24 hours. The results were also significant, but not quite as good, using a HDG substrate.

As discussed above another advantage of the present coating solution is that it can easily accommodate the addition of organic resins to further enhance the corrosion protection without requiring complex multi-step processing or applications. The desired resin can merely be added to the coating solution. In a first example of combining the inorganic coating solution with an organic resin use was made of polyvinyl dichloride (PVDC) as the organic resin. The PVDC resin used was Noveon XPD-2903. A series of coating solutions were prepared as described below in Table 2.

TABLE 2

| Component | Formula 57B | Formula 57C | Formula 57D |
|---|---|---|---|
| Deionized water | 73.50 | 63.50 | 53.50 |
| Bacote 20 ® | 16.00 | 16.00 | 16.00 |
| V₂O₅ | 0.50 | 0.50 | 0.50 |
| PVDC | 10.00 | 20.00 | 30.00 |

Each formula was then coated onto a series of HDG panels and a series of USS Galvalume® panels using the dry in place process described above at a coating weight of 200 milligrams per square foot (200 milligrams per 929.03 square centimeters) and dried to a PMT of 210° F. (98° C.). A series of control HDG and USS Galvalume® panels were created using the commercially available non-chrome containing coating Granocoat® 342™ (G342) available from Henkel. The G342 was applied per the manufacture's instructions. In a first test panels were subjected to a NSS test as described above and multiples of each time point were evaluated for the percent corrosion and the average calculated. The results are presented below in Table 3 wherein the abbreviation Gal. indicates the USS Galvalume® panels.

TABLE 3

| Time | | | | | | | | |
|---|---|---|---|---|---|---|---|---|
| hours | G342 | 57B | 57C | 57D | G342 | 57B | 57C | 57D |
| (NSS) | Gal. | Gal. | Gal. | Gal. | HDG | HDG | HDG | HDG |
| 24 | 0.10 | 0.03 | 0.00 | 0.00 | 0.00 | 1.10 | 0.13 | 0.77 |
| 48 | 0.10 | 0.03 | 0.00 | 0.00 | 0.20 | 1.10 | 0.30 | 2.67 |
| 72 | 0.33 | 0.33 | 0.00 | 0.00 | 0.67 | 1.67 | 4.33 | 3.00 |
| 96 | 0.67 | 0.33 | 0.00 | 0.00 | 2.67 | 3.67 | 8.67 | 7.33 |
| 168 | 5.00 | 1.00 | 0.00 | 0.00 | 17.00 | 8.67 | 18.33 | 20.00 |
| 336 | 13.33 | 1.00 | 0.03 | 0.05 | 63.33 | 35.00 | 56.67 | 43.33 |
| 504 | 48.67 | 2.67 | 0.33 | 0.50 | | 60.00 | 75.00 | 70.00 |
| 672 | 76.67 | 2.67 | 2.33 | 1.00 | | | | |
| 840 | | 3.00 | 4.33 | 3.00 | | | | |
| 1200 | | 10.67 | 9.00 | 3.00 | | | | |

The results conclusively demonstrate the enhanced corrosion protection provided by the coating solution of the present invention. In viewing the data on the USS Galvalume® panels one begins to see an improvement in corrosion protection in all of the panels compared to the G342 control by 168 hours of testing and the differences increase with increased testing time. After 504 hours of testing the panels coated according to the present invention have from 18 to 147 fold less corrosion than the control G342 panels. By 840 hours the control G342 panels have from 28 to 76 times as much corrosion as the panels coated according to the present invention. Even after 1200 hours of testing the panels coated according to the present invention have only 3 to 11% corrosion. These results are dramatic and show the power of the coating solution prepared according to the present invention. The results also demonstrate that increasing the level of polyvinyl dichloride from 10% to 30% had a small effect on the degree of corrosion protection at the last time point. Turning to data from the HDG panels one can see that coatings according to the present invention also provide enhanced protection compared to the G342 up to a point of about 504 hours. The results with the HDG panels are not as dramatic as for the USS Galvalume® panels. Also, the effect of increasing the level of polyvinyl dichloride seems to be the opposite of that seen on the USS Galvalume® panels. The higher the level of polyvinyl dichloride the worse the coating seemed to be in protecting from corrosion for the HDG panels.

In the next series of corrosion testing panels of USS Galvalume® or HDG were coated as described above using the formulas from Table 2 at 200 milligrams per square foot (200 milligrams per 929.03 square centimeters) and dried in place to a PMT of 210° F. (98° C.) onto the panels. Then a Stack Test was performed to simulate panels in contact with each other in a humid environment. The Stack Test was performed by spraying deionized water onto a coated side of a first panel, placing a coated side of a second panel against the coated side of the first panel and then clamping the first and second panels together. The clamped panels are then placed in a humidity test chamber at 100° F. (38° C.) and 100% humidity. After various time points multiples of each condition are removed and the percent corrosion of each is determined and the results averaged. The averaged results are presented below in Table 4.

TABLE 4

| Time | | | | | | | | |
|---|---|---|---|---|---|---|---|---|
| hours | G342 | 57B | 57C | 57D | G342 | 57B | 57C | 57D |
| (Stack) | Gal. | Gal. | Gal. | Gal. | HDG | HDG | HDG | HDG |
| 168 | 3.00 | 0.00 | 0.00 | 0.00 | 0.00 | 0.00 | 0.00 | 0.00 |
| 336 | 5.00 | 0.00 | 0.00 | 0.00 | 5.00 | 3.00 | 1.00 | 1.00 |
| 504 | 5.00 | 0.00 | 0.00 | 7.00 | 5.00 | 3.00 | 3.00 | 5.00 |
| 672 | 7.00 | 0.00 | 1.00 | 8.00 | 5.00 | 5.00 | 10.00 | 16.00 |
| 840 | 8.25 | 0.50 | 1.00 | 12.00 | 10.00 | 16.00 | 25.00 | 30.00 |
| 1200 | 10.00 | 2.00 | 3.00 | 12.00 | 50.00 | 40.00 | 60.00 | 60.00 |
| 1344 | 10.00 | 2.00 | 3.00 | 16.00 | | | | |
| 1512 | 10.00 | 2.00 | 3.00 | 20.00 | | | | |
| 1680 | 10.00 | 3.00 | 7.00 | 23.33 | | | | |
| 1848 | 20.00 | 5.00 | 7.00 | 30.00 | | | | |
| 2016 | 22.50 | 5.00 | 10.00 | 40.00 | | | | |

The results demonstrate that for resin levels of 10 and 20% the coating solution according to the present invention performed much better than the G342 coating at all time points by a factors of 16 to 2.2 fold depending on the time point. The coating having 30% PVDC, however, did not perform as well as the control G342 panels after 1200 hours and by 2016 hours it showed about twice as much corrosion as the control panel. The reason for this difference is unknown. With respect to the HDG panels the results show less difference between the control panels and the coatings according to the present invention. The panels all show significant corrosion protection out to 504 hours. Thereafter the coating solutions with 20 and 30% PVDC performed worse than the G342 panels and than the 10% PVDC panels.

In the next series of corrosion testing panels of USS Galvalume® or HDG were coated as described above using the formulas from Table 2 at 200 milligrams per square foot (200 milligrams per 929.03 square centimeters) and dried in place to a PMT of 210° F. (98° C.) onto the panels. Then a Cleveland humidity test (CHT) was performed on the panels using ASTM method D4585. The results are presented below in Table 5.

TABLE 5

| Time | | | | | | | | |
|---|---|---|---|---|---|---|---|---|
| hours | G342 | 57B | 57C | 57D | G342 | 57B | 57C | 57D |
| (CHT) | Gal. | Gal. | Gal. | Gal. | HDG | HDG | HDG | HDG |
| 168 | 0.00 | 0.00 | 0.00 | 0.00 | 0.00 | 0.00 | 0.00 | 0.00 |
| 336 | 7.00 | 3.00 | 0.00 | 0.00 | 7.00 | 3.00 | 0.00 | 0.00 |
| 504 | 7.00 | 3.00 | 0.00 | 0.00 | 10.00 | 3.00 | 0.00 | 0.00 |
| 672 | 7.00 | 3.00 | 0.00 | 0.00 | 10.00 | 3.00 | 0.00 | |
| 840 | 7.00 | 3.00 | 0.00 | 0.00 | 10.00 | 3.00 | 1.00 | |
| 1200 | 7.00 | 7.00 | 1.00 | 0.3 | 16.00 | 5.00 | 5.00 | |

The USS Galvalume® results demonstrate that coating solution of the present invention performs much better than the control G342 coating except for 1200 hours at 10% PVDC which is equivalent to the control G342. The results also clearly demonstrate that increasing the amount of PVDC has a very positive effect on the corrosion protection of the coating prepared according to the present invention. Similar results are seen on the HDG panels with the coating according to the present invention providing significantly enhanced corrosion protection compared to the G342. In addition, increasing the amount of PVDC seems to enhance the corrosion protection.

In the next series of corrosion testing panels of USS Galvalume® or HDG were coated as described above using the formulas from Table 2 at 200 milligrams per square foot (200 milligrams per 929.03 square centimeters) and dried in place to a PMT of 210° F. (98° C.) onto the panels. Then a Butler water immersion (BWI) test was performed on a series of the panels. Each test panel is supported and immersed in a tank of distilled water such that there is one half an inch of water below each panel and three quarters of an inch of water above each panel. The tanks with the panels are then placed in a humidity chamber set at 100% humidity and 100° F. (38° C.). Panels are removed at the selected time points and evaluated for the percent corrosion. The results are presented below in Table 6.

TABLE 6

| Time | | | | | | | | |
|---|---|---|---|---|---|---|---|---|
| hours | G342 | 57B | 57C | 57D | G342 | 57B | 57C | 57D |
| (BWI) | Gal. | Gal. | Gal. | Gal. | HDG | HDG | HDG | HDG |
| 168 | 0.00 | 0.00 | 1.00 | 0.00 | 0.00 | 1.00 | 0.00 | 0.00 |
| 336 | 0.00 | 0.00 | 1.00 | 1.00 | 16.00 | 1.00 | 0.00 | 1.00 |
| 504 | 0.00 | 0.00 | 1.00 | 1.00 | 50.00 | 1.00 | 0.00 | 3.00 |
| 672 | 3.00 | 0.00 | 1.00 | 1.00 | | 1.00 | 0.00 | 3.00 |
| 840 | 7.00 | 7.00 | 1.00 | 3.00 | | 7.00 | 7.00 | 7.00 |
| 1200 | 16.00 | 7.00 | 3.00 | 10.00 | | 25.00 | 16.00 | 10.00 |
| 1344 | 16.00 | 7.00 | 3.00 | 10.00 | | 25.00 | 16.00 | 16.00 |
| 1572 | 20.00 | 7.00 | 3.00 | 10.00 | | 30.00 | 16.00 | 16.00 |
| 1680 | 20.00 | 7.00 | 3.00 | 10.00 | | 30.00 | 20.00 | 20.00 |
| 1848 | 25.00 | 7.00 | 3.00 | 10.00 | | 30.00 | 20.00 | 25.00 |
| 2016 | 30.00 | 7.00 | 3.00 | 16.00 | | 40.00 | 30.00 | 40.00 |

The USS Galvalume® results demonstrate that the coatings prepared according to the present invention provide significantly more corrosion protection than the control G342 coating. The enhanced protection ranges from an approximately 2 fold to 10 fold increased corrosion resistance compared to G342. The effect of PVDC level on the corrosion protection appears complex and non-linear with the highest level appearing less efficient than levels of from 10 to 20% by weight. The HDG panels also show the benefit of the coatings according to the present invention versus G342. All of the panels coated according to the present invention showed enhanced corrosion protection compared to G342. Again the effect of PVDC level was complex and seemed to show best results with 20% PVDC.

As shown above an advantage of the present coating is that it can easily accommodate the addition of organic resins to further enhance the corrosion protection with out requiring complex multi-step processing or applications. The desired resin can merely be added to the coating solution. In a second example of combining the inorganic coating with an organic resin use was made of a thermoplastic styrene-acrylic copolymer emulsion, designated Carboset® CR-760, as the organic resin. The Carboset® CR-760 is available from Lubrizol Advanced Materials, Inc. of Cleveland Ohio. The Carboset® CR-760 has approximately 42% by weight solids. In additional coatings the Carboset® CR-760 was further combined with the PVDC used above. In additional formulations the coating solution also included a carnauba wax emulsion to enhance formability of the coating solution. The carnauba wax emulsion used was Michem® Lube 160 available from Michelman, Inc. of Cincinnati Ohio. A series of coating solutions were prepared as described below in Table 7. Each formula was then coated onto a series of HDG panels and a series of USS Galvalume panels using the dry in place process described above at a coating weight of 175 to 180 milligrams per square foot (175 to 180 milligrams per 929.03 square centimeters) and dried to a PMT of 210° F. (98° C.). In a first corrosion test panels were subjected to a NSS test as described above and multiple panels of each time point were evaluated for the percent corrosion. The average results for each time point for the NSS test are presented below in Table 8. No samples for NSS for formula 162B were run. Additional panels were used to evaluate the coatings using the Butler water immersion test, the Cleveland humidity test, and the Stack Test each performed as described above. The results of these tests are present below in Tables 9, 10 and 11 respectively.

TABLE 7

| Component | 162A | 162B | 162C | 162D |
|---|---|---|---|---|
| Deionized | 32.50 | 26.00 | 39.50 | 33.00 |
| water | | | | |
| Bacote | 16.00 | 16.00 | 16.00 | 16.00 |
| 20 ® | | | | |
| V₂O₅ | 0.50 | 0.50 | 0.50 | 0.50 |
| Carboset ® | 51.00 | 51.00 | 26.00 | 26.00 |
| CR760 | | | | |
| PVDC | | | 18.00 | 18.00 |
| Camauba | | 6.50 | | 6.50 |
| wax | | | | |

TABLE 8

| Time | | | | | | | | |
|---|---|---|---|---|---|---|---|---|
| hours | 162A | 162B | 162C | 162D | 162A | 162B | 162C | 162D |
| (NSS) | Gal. | Gal. | Gal | Gal. | HDG | HDG | HDG | HDG |
| 24 | 0.00 | 0.00 | 0.00 | 0.00 | 0.00 | | 7.00 | 7.00 |
| 48 | 0.00 | 0.00 | 0.00 | 0.00 | 23.66 | | 16.00 | 20.00 |
| 168 | 0.00 | 1.00 | 0.70 | 0.00 | 100.00 | | 86.67 | 93.33 |
| 336 | 0.00 | 3.33 | 8.67 | 0.00 | | | | |
| 504 | 1.00 | 5.67 | 6.00 | 0.00 | | | | |
| 672 | 1.00 | 8.67 | 10.00 | 0.00 | | | | |
| 840 | 1.00 | 8.67 | 10.00 | 1.00 | | | | |
| 1008 | 1.00 | 15.00 | 16.00 | 1.00 | | | | |
| 1176 | 1.00 | 20.00 | 25.00 | 5.00 | | | | |
| 1344 | 5.00 | 25.33 | 50.00 | 15.33 | | | | |
| 1512 | 5.67 | 28.67 | | 17.33 | | | | |
| 1680 | 6.33 | 30.00 | | 20.00 | | | | |
| 1848 | 6.33 | 23.33 | | 20.00 | | | | |
| 2016 | 6.33 | 36.67 | | 21.67 | | | | |

The USS Galvalume® results demonstrate that the coatings according to the present invention all were more effective than the G342 coating was in the results reported in Table 3 above. The coating with just Carboset® CR760 was very effective even out as far as 2016 hours. The comparison of formula 162A to 162B shows that addition of the carnauba wax to this formula appears to reduce the coating effectiveness as a corrosion protection coating. The results also show that combining the Carboset® CR760 with PVDC reduces the effectiveness of the coating solution compared to use of Carboset® CR760 alone, however, addition of the carnauba wax to the blend seems to enhance its effectiveness. None of the coatings appear to be very effective on the HDG samples and presence of carnauba wax or PVDC does not seem to affect the performance of Carboset® CR760 alone.

TABLE 9

| Time | | | | | | | | |
|---|---|---|---|---|---|---|---|---|
| hours | 162A | 162B | 162C | 162D | 162A | 162B | 162C | 162D |
| (BWI) | Gal. | Gal. | Gal | Gal. | HDG | HDG | HDG | HDG |
| 168 | 0.00 | 0.00 | 0.00 | 0.00 | 0.00 | 0.00 | 0.00 | 0.00 |
| 336 | 1.00 | 1.00 | 0.00 | 0.00 | 0.00 | 0.00 | 0.00 | 0.00 |
| 504 | 3.00 | 3.00 | 1.00 | 1.00 | 0.00 | 3.00 | 5.00 | 5.00 |
| 672 | 5.00 | 3.00 | 3.00 | 1.00 | 1.00 | 5.00 | 5.00 | 5.00 |
| 840 | 5.00 | 5.00 | 3.00 | 1.00 | 1.00 | 7.00 | 7.00 | 10.00 |
| 1008 | 5.00 | 5.00 | 5.00 | 1.00 | 1.00 | 7.00 | 7.00 | 16.00 |
| 1176 | 16.00 | 10.00 | 10.00 | 1.00 | 1.00 | 1.00 | 16.00 | 20.00 |
| 1344 | 16.00 | 16.00 | 16.00 | 3.00 | 3.00 | 7.00 | 20.00 | 20.00 |
| 1512 | 16.00 | 16.00 | 20.00 | 3.00 | 3.00 | 10.00 | 25.00 | 30.00 |
| 1680 | 16.00 | 16.00 | 30.00 | 5.00 | 7.00 | 30.00 | 30.00 | 30.00 |
| 1848 | 16.00 | 16.00 | 30.00 | 5.00 | 7.00 | 30.00 | 50.00 | 50.00 |
| 2016 | 16.00 | 16.00 | 40.00 | 5.00 | 7.00 | 40.00 | | |

The results with the USS Galvalume® panels demonstrate that with the exception of the blend of Carboset® CR760 and PVDC all of the coatings performed better than did G342 from Table 6. In the BWI test there was not a detrimental effect on performance for Carboset® CR760 alone. In contrast to the NSS test, the combination of Carboset® CR760 with PVDC and carnauba wax performed the best in the BWI test. Again as seen in the NSS test results there is a benefit to including the carnauba wax when combining the Carboset® CR760 with PVDC. The results with the HDG panels also show that all of the coatings prepared according to the present invention performed better than did G342 from Table 6. Significantly better performance was obtained with the Carboset® CR760 alone compared to addition of carnauba wax, PVDC, or carnauba wax and PVDC.

TABLE 10

| Time | | | | | | | | |
|---|---|---|---|---|---|---|---|---|
| hours | 162A | 162B | 162C | 162D | 162A | 162B | 162C | 162D |
| (CHT) | Gal. | Gal. | Gal | Gal. | HDG | HDG | HDG | HDG |
| 168 | 0.00 | 0.00 | 0.00 | 0.00 | 0.00 | 0.00 | 0.00 | 0.00 |
| 336 | 0.00 | 0.00 | 0.00 | 0.00 | 0.00 | 0.00 | 0.00 | 0.00 |
| 504 | 3.00 | 3.00 | 3.00 | 1.00 | 0.00 | 3.00 | 5.00 | 5.00 |
| 672 | 3.00 | 3.00 | 3.00 | 2.00 | 0.00 | 3.00 | 5.00 | 5.00 |
| 840 | 3.00 | 3.00 | 3.00 | 3.00 | 1.00 | 3.00 | 5.00 | 5.00 |
| 1008 | 3.00 | 3.00 | 3.00 | 3.00 | 3.00 | 3.00 | 5.00 | 5.00 |

The results for both the USS Galvalume® and HDG show that in the Cleveland humidity test all of the coatings according to the present invention performed equally well irrespective of the substrate and that all performed better than the results seen with the control G342 in Table 5.

TABLE 11

| Time | | | | | | | | |
|---|---|---|---|---|---|---|---|---|
| hours | 162A | 162B | 162C | 162D | 162A | 162B | 162C | 162D |
| (Stack) | Gal. | Gal. | Gal | Gal. | HDG | HDG | HDG | HDG |
| 168 | 0.00 | 0.00 | 0.00 | 0.00 | 0.00 | 0.00 | 0.00 | 0.00 |
| 336 | 0.00 | 1.00 | 0.00 | 0.00 | 0.00 | 0.00 | 1.00 | 1.00 |
| 504 | 0.00 | 1.00 | 1.00 | 1.00 | 5.00 | 5.00 | 10.00 | 7.00 |
| 672 | 0.00 | 3.00 | 1.00 | 1.00 | 10.00 | 20.00 | 30.00 | 16.00 |
| 840 | 1.00 | 5.00 | 1.00 | 3.00 | 10.00 | 20.00 | 30.00 | 37.50 |
| 1008 | 1.00 | 5.00 | 3.00 | 3.00 | 20.00 | 30.00 | 40.00 | 40.00 |
| 1176 | 1.00 | 5.00 | 3.00 | 5.00 | 30.00 | 40.00 | | |
| 1344 | 3.00 | 5.00 | 3.00 | 5.00 | 50.00 | | | |
| 1512 | 3.00 | 7.00 | 3.00 | 5.00 | | | | |
| 1680 | 3.00 | 7.00 | 3.00 | 5.00 | | | | |
| 1848 | 3.00 | 7.00 | 3.00 | 5.00 | | | | |
| 2016 | 5.00 | 7.00 | 5.00 | 5.00 | | | | |

The USS Galvalume® results demonstrate that all of the coatings according to the present invention performed equally well in the Stacks Test and that they performed better than the control G342 in Table 4. The HDG results were different, the Carboset® CR760 alone seemed to perform the best with the other coatings performing worse. None of the coatings seemed to perform much better than the G342 in Table 4.

In another series of tests the amount of ammonium zirconyl carbonate in the coating was varied to vary the amount of ZrO₂ in the coating solution and the effect on corrosion protection was determined. The coating formulas are given below in Table 12. In addition, control panels were coated with G342 as described above. The coatings were applied to USS Galvalume® panels at a coating weight of approximately 200 milligrams per square foot (200 milligrams per 929.03 square centimeters) as described above and dried in place to a PMT of 210° F. (98° C.). The panels were then tested in the NSS, Butler water immersion test, and Stack Test and the results are given below in Tables 13, 14, and 15 respectively.

TABLE 12

| Component | 162A | 162B | 183A/F | 183E |
|---|---|---|---|---|
| Deionized water | 32.50 | 26.00 | 40.50 | 42.50 |
| Bacote 20 ® | 16.00 | 16.00 | 8.00 | 6.00 |
| V₂O₅ | 0.50 | 0.50 | 0.50 | 0.50 |
| Carboset ® | 51.00 | 51.00 | 51.00 | 51.00 |
| CR760 | | | | |
| Carnauba wax | | 6.50 | | |

TABLE 13

| Time | | | | | |
|---|---|---|---|---|---|
| hours | | | | | |
| (NSS) | G342 | 162A | 162B | 183A/F | 183E |
| 24 | 0.00 | 0.00 | 0.00 | 0.00 | 0.00 |
| 72 | 0.00 | 0.00 | 0.00 | 0.00 | 0.00 |
| 168 | 3.00 | 0.00 | 0.00 | 0.00 | 1.00 |
| 336 | 31.67 | 0.00 | 0.00 | 3.83 | 21.67 |
| 504 | 60.00 | 0.00 | 1.00 | 31.00 | 80.00 |
| 672 | | 1.00 | 1.00 | 31.50 | |
| 840 | | 1.00 | 1.00 | 25.33 | |
| 1032 | | 1.00 | 1.00 | 35.33 | |
| 1172 | | 1.00 | 1.00 | 30.00 | |
| 1344 | | 1.67 | 3.00 | 40.00 | |
| 1560 | | 2.00 | 3.00 | 40.00 | |
| 1728 | | 4.00 | 5.00 | 50.00 | |

The results demonstrate that all of the coatings according to the present invention were at least as effective as G342 and most were much more effective. The results also demonstrate that increasing the level of ZrO₂ from 1.20% to 3.20% dramatically increased the effectiveness of the coatings prepared according to the present invention.

TABLE 14

| Time | | | | | |
|---|---|---|---|---|---|
| hours | | | | | |
| (BWI) | G342 | 162A | 162B | 183A/F | 183E |
| 168 | 0.00 | 0.00 | 0.00 | 0.00 | 0.00 |
| 336 | 0.00 | 0.00 | 0.00 | 0.00 | 0.00 |
| 504 | 0.00 | 0.00 | 1.00 | 0.00 | 1.00 |
| 672 | 0.00 | 1.00 | 3.00 | 0.50 | 3.00 |
| 840 | 0.00 | 3.00 | 3.00 | 0.50 | 3.00 |
| 1032 | 0.00 | 3.00 | 3.00 | 3.00 | 7.00 |
| 1176 | 10.00 | 5.00 | 5.00 | 4.00 | 10.00 |
| 1344 | 30.00 | 7.00 | 7.00 | 4.00 | 20.00 |
| 1512 | 50.00 | 7.00 | 7.00 | 5.00 | 20.00 |
| 1680 | | 1.00 | 1.00 | 3.00 | 20.00 |
| 1848 | | 3.00 | 3.00 | 5.00 | 20.00 |
| 2016 | | 5.00 | 5.00 | 7.5 | 20.00 |

The results again demonstrate that the coatings according to the present invention all perform much better than G342. In addition, although not as dramatic as for the NSS test, the results demonstrate that increasing the amount of ZrO₂ increases the effectiveness of the coating in corrosion protection.

TABLE 15

| Time | | | | | |
|---|---|---|---|---|---|
| hours | | | | | |
| (Stack) | G342 | 162A | 162B | 183A/F | 183E |
| 168 | 0.00 | 0.00 | 0.00 | 0.00 | 0.00 |
| 336 | 0.00 | 0.00 | 0.00 | 0.00 | 0.00 |
| 504 | 1.00 | 1.00 | 0.00 | 0.00 | 0.0 |
| 672 | 1.00 | 3.00 | 0.00 | 0.00 | 1.00 |
| 840 | 3.00 | 3.00 | 1.00 | 2.00 | 1.00 |
| 1032 | 3.00 | 3.00 | 3.00 | 2.00 | 1.00 |
| 1176 | 3.00 | 5.00 | 3.00 | 3.00 | 3.00 |
| 1344 | 5.00 | 5.00 | 5.00 | 3.00 | 3.00 |
| 1512 | 7.00 | 5.00 | 5.00 | 4.00 | 5.00 |
| 1680 | 10.00 | 5.00 | 5.00 | 5.00 | 5.00 |
| 1848 | 10.00 | 5.00 | 5.00 | 6.00 | 5.00 |
| 2016 | 10.00 | 5.00 | 7.00 | 13.00 | 7.00 |

The results also demonstrate that the coatings according to the present invention perform better than the control G342, however, there was not the same increase in effectiveness with increasing ZrO₂ as was seen in the other tests.

In the next series of experiments two additional resins 3272-096 and 3272-103 were prepared as detailed below and then these resins were used to create coatings according to the present invention as detailed in Table 16 below.

### Resin 3272-096

The resin 3272-096 included as monomers: acetoacetoxyethyl methacrylate (AAEM), n-butyl methacrylate, styrene, methyl methacrylate, 2-ethylhexyl acrylate, and ADD APT PolySurf HP which is a mixture of methacrylated mono and di-phosphate ester. The total monomer distribution in the resin was as follows: 20.00% AAEM, 12.50% n-butyl methacrylate, 15.00% styrene, 27.50% methyl methacrylate, 20.00% 2-ethylhexyl acrylate, and 5.00% ADD APT PolySurf HP. The resin polymerization reaction was run under N₂ with stirring and a heat set point of 80° C. The initial charge to the reaction vessel was 241.10 grams of DI water, 2.62 grams of ammonium lauryl sulfate (Rhodapon L-22 EP), and 2.39 grams of ferrous sulfate 0.5% FeSO₄7H₂O (3 ppm). This initial charge was put into the reaction vessel at time zero and heating to the set point was begun. After 30 minutes a reactor seed comprising a combination of 5.73 grams of DI water, 0.90 grams of non-ionic surfactant (Tergitol 15-S-20), 0.13 grams of ammonium lauryl sulfate (Rhodapon L-22 EP), 2.15 grams of n-butyl methacrylate, 2.57 grams of styrene, 4.74 grams of methyl methacrylate, 3.48 grams of 2-ethylhexyl acrylate, 3.41 grams of acetoacetoxyethyl methacrylate (AAEM), and 0.85 grams of ADD APT PolySurf HP was added to the reaction vessel and heating to the set point was continued for another 15 minutes. Then an initial initiator charge was added to the vessel comprising 0.32 grams of HOCH₂SO₂Na, 4.68 grams of DI water, 0.45 grams of tert-butylhydroperoxide, and an additional 4.54 grams of DI water and the temperature was maintained at the set point for another 30 minutes. Then the monomer and initiator co-feeds were added to the vessel over a three hour period with the temperature maintained at the set point. The monomer co-feed was 106.92 grams of DI water, 17.10 grams of Tergitol 15-S-20, 2.49 grams of Rhodapon L-22 EP, 40.89 grams of n-butyl methacrylate, 48.83 grams of styrene, 89.97 grams of methyl methacrylate, 66.10 grams of 2-ethylhexyl acrylate, 64.77 grams of AAEM, and 16.19 grams of ADD APT PolySurf HP. The initiator co-feed was 0.97 grams of HOCH₂SO₂Na, 14.03 grams of DI water, 1.39 grams of tert-butylhydroperoxide, and an additional 13.61 grams of DI water. After the three hours a chaser charge was added to the vessel over a 30 minute period. The chaser charge was 0.32 grams of HOCH₂SO₂Na, 4.88 grams of DI water, 0.46 grams of tert-butylhydroperoxide, and an additional 4.54 grams of DI water. The vessel was then held at the set point for one hour and 30 minutes. Then the cool down from the set point was begun and continued for 2 hours until the temperature was 38° C. Then the buffer co-feed was added to the vessel. The buffer co-feed was 5.19 grams of ammonium hydroxide (28%) and 18.48 grams of DI water. In this resin formation and that for 3272-103 detailed below another potential phosphate containing monomer that could be used in place of the ADD APT PolySurf HP is Ebecryl 168 from Radcure Corporation. Additional non-ionic surfactant stabilizers that could be used in place of Tergitol 15-S-20, which is a secondary alcohol ethoxylate, are other non-ionic stabilizers having a hydrophilic lipophilic balance of from 15 to 18. Examples of these stabilizers include: other secondary alcohol ethoxylates such as Tergitol 15-S-15; blends of ethoxylates such as Abex 2515; alkyl polyglycol ether such as Emulsogen LCN 118 or 258; tallow fatty alcohol ethoxylate such as Genapol T 200 and T 250; isotridecyl alcohol ethoxylates such as Genapol X 158 and X 250; tridecyl alcohol ethoxylates such as Rhodasurf BC-840; and oleyl alcohol ethoxylates such as Rhodasurf ON-877.

### Resin 3272-103

The organic coating resin 3272-103 was prepared as described below. The resin includes as monomers: acetoacetoxyethyl methacrylate (AAEM), n-butyl methacrylate, styrene, methyl methacrylate, 2-ethylhexyl acrylate, and ADD APT PolySurf HP which is a mixture of methacrylated mono and di-phosphate ester. The total monomer distribution in the resin was as follows: 20.00% AAEM, 12.50% n-butyl methacrylate, 15.00% styrene, 27.50% methyl methacrylate, 20.00% 2-ethylhexyl acrylate, and 5.00% ADD APT PolySurf HP. The resin polymerization reaction was run under N₂ with stirring and a heat set point of 80° C. The initial charge to the reaction vessel was 286.10 grams of DI water, 2.47 grams of Rhodapon L-22 EP. This initial charge was put into the reaction vessel at time zero and heating to the set point was begun. After 30 minutes a reactor seed comprising a combination of 5.44 grams of DI water, 0.85 grams of Tergitol 15-S-20, 0.12 grams of Rhodapon L-22 EP, 2.04 grams of n-butyl methacrylate, 2.44 grams of styrene, 4.49 grams of methyl methacrylate, 3.30 grams of 2-ethylhexyl acrylate, 3.24 grams of acetoacetoxyethyl methacrylate (AAEM), and 0.81 grams of ADD APT PolySurf HP was added to the reaction vessel and heating to the set point was continued for another 15 minutes. Then an initial initiator charge was added to the vessel comprising 4.79 grams of DI water and 0.21 grams of (NH₄)₂S₂O₈ and the temperature was maintained at 80° C. for another 30 minutes. Then the monomer and initiator co-feeds were added to the vessel over a three hour period with the temperature maintained at the set point. The monomer co-feed was 103.36 grams of DI water, 16.15 grams of Tergitol 15-S-20, 2.35 grams of Rhodapon L-22 EP, 38.81 grams of n-butyl methacrylate, 46.34 grams of styrene, 85.38 grams of methyl methacrylate, 62.73 grams of 2-ethylhexyl acrylate, 61.47 grams of AAEM, and 15.37 grams of ADD APT PolySurf HP. The initiator co-feed was 14.36 grams of DI water and 0.64 grams of (NH₄)₂S₂O₈. After the three hours a chaser charge was added to the vessel over a 30 minute period. The chaser charge was 0.35 grams of ascorbic acid, 4.65 grams of DI water, 0.44 grams of tert-butylhydroperoxide, an additional 4.56 grams of DI water, and 2.39 grams of ferrous sulfate 0.5% FeSO₄7H₂O (3 ppm). The vessel was then held at the set point for one hour and 30 minutes. Then the cool down was begun and continued for 2 hours until the temperature was 38° C. Then the buffer co-feed was added to the vessel. The buffer co-feed was 5.88 grams of ammonium hydroxide (28%) and 18.48 grams of DI water.

Taking the resins above a series of coatings were created to examine the effect of alkaline treatment on the coatings and the benefit of including V₂O₅ plus a reducing agent, cysteine, in the coating. Other reducing agents for the V⁺⁵ could include Sn⁺², or ascorbic acid, or thiosuccinic acid, or one could start with V⁺⁴ from vanadyl sulfate or vanadyl acetylacetonate. The coatings from Table 16 were then applied to HDG panels at a coating weight of approximately 200 milligrams per square foot (200 milligrams per 929.03 square centimeters) to each panel and then dried to a PMT of either 200° F. or 300° F. (93 or 149° C.) and either put directly into the NSS test or first washed with the alkaline cleaner PCI 338 and then put into the NSS test. A decrease in corrosion protection after pre-treatment with PCI 338 would indicate that the coatings were not alkaline resistant. The results of the NSS test are given in Table 17 below.

TABLE 16

| Component | 8A | 8H | 9A | 9H |
|---|---|---|---|---|
| Deionized water | 66.00 | 66.00 | 65.00 | 65.00 |
| Bacote 20 ® | 24.00 | 24.00 | 24.00 | 24.00 |
| V₂O₅ | | | 0.50 | 0.50 |
| Cysteine | | | 0.50 | 0.50 |
| 3272-096 | 10.00 | | 10.00 | |
| 3272-103 | | 10.00 | | 10.00 |

TABLE 17

| | Time | | | | |
|---|---|---|---|---|---|
| | hours | | | | |
| Treatment | (NSS) | 8A | 8H | 9A | 9H |
| PMT of 200° | 24 | 10.00 | 16.00 | 0.00 | 0.00 |
| F.(93° C.), no | 48 | 30.00 | 60.00 | 3.70 | 1.00 |
| treatment | 72 | 60.00 | | 8.70 | 1.00 |
| with PCl 338 | 96 | | | 11.30 | 43.00 |
| | 168 | | | 50.00 | 33.30 |
| | 336 | | | | 76.70 |
| PMT of 300 | 24 | 80.00 | 50.00 | 0.00 | 0.00 |
| F. (149° C.), | 48 | | | 0.00 | 1.00 |
| no treatment | 72 | | | 0.00 | 18.70 |
| with PCl 338 | 96 | | | 1.70 | 40.00 |
| | 168 | | | 50.00 | 65.30 |
| | 336 | | | | 93.30 |
| PMT 200° F. | 24 | 20.00 | 16.00 | 7.00 | 3.00 |
| (93° C.), pre- | 48 | 50.00 | 60.00 | 50.00 | 30.00 |
| treat with | 72 | 60.00 | | 50.00 | 50.00 |
| PCl 338 | 96 | | | 50.00 | |
| | 168 | | | 50.00 | |
| PMT of 300° | 24 | 80.00 | 50.00 | 3.00 | 0.00 |
| F. (149° C.), | 48 | | | 10.00 | 20.00 |
| pre-treat with | 72 | | | 80.00 | 50.00 |
| PCl 338 | | | | | |

The results demonstrate that for either resin the presence of V₂O₅ and cysteine was highly beneficial to the corrosion protection ability. Coatings prepared according to the present invention are designed to be applied directly to bare metal substrates without the need for any phosphate or other pre-treatments other than cleaning. They can be applied at any desired coating weight required by the situation, preferably they are applied at a coating weight of from 150 to 400 milligrams per square foot (150 to 400 milligrams per 929.03 square centimeters), more preferably at from 175 to 300 milligrams per square foot (175 to 300 milligrams per 929.03 square centimeters) and most preferably at from 175 to 250 milligrams per square foot (175 to 250 milligrams per 929.03 square centimeters). The coatings of the present invention are dry in place conversion coatings as known in the art and are preferably dried to a peak metal temperature of from 110 to 350° F. (43 to 177° C.), more preferably from 180 to 350° F. (82 to 177° C.), most preferably to a PMT of from 200 to 325° F. (93 to 163° C.).

Another series of coating solutions were prepared to demonstrate the need for elements both from group IVB and group VB. Initially a resin 3340-082 was created using the components below in Table 18 as described below.

TABLE 18

| | | Wt |
|---|---|---|
| | | added |
| Part | Material | gms |
| A | Deionized water | 245.3 |
| | Rhodapon L22 | 1.7 |
| B1 | Deionized water | 76.1 |
| | Rhodapon L22 | 1.7 |
| | Tergital 15-S-20 | 11.9 |
| B2 | n-butyl methacrylate | 28.6 |
| | Styrene | 34.1 |
| | Methyl methacrylate | 62.9 |
| | 2-ethylhexyl acrylate | 46.2 |
| | Acetoacetoxyethyl Methacrylate | 45.3 |
| | Polysurf HP | 11.3 |
| C | Ammonium persulfate | 0.60 |
| | Deionized water | 11.4 |
| D | 70% t-butylhydroperoxide | 0.31 |
| | Deionized water | 9.7 |
| E | Ascorbic acid | 0.17 |
| | Deionized water | 9.8 |
| F | 0.5% aqueous ferrous sulfate | 1.8 |
| G | Ammonium hydroxide 28.8% | 4.3 |
| | Deionized water | 10.5 |
| H | Deionized water | 14.4 |

Part A was added to a four-necked 3 liter flask equipped with a stirrer, a condenser, a thermocouple and a nitrogen inlet. The contents were heated to and maintained at 80° C. under nitrogen atmosphere. Parts B1 and B2 were mixed separately to form uniform clear solutions. B1 and B2 were mixed together to form pre-emulsion B. An amount of 5% of pre-emulsion B and 25% of part C were charged to the flask and maintained at 80° C. After 40 minutes the remainder of pre-emulsion B and part C were added at a constant rate to the flask over a period of 3 hours after which part H was used to flush the pre-emulsion addition pump into the flask. The flask contents were cooled to 70° C. at which time part F was added to the flask. Parts D and E were added to the flask over a period of 30 minutes, after which the mixture was maintained at 70° C. for a period of 1 hour. The mixture was then cooled to 40° C. at which time part G was added. The resulting latex had a solids content of 37.2%, a pH of 6.9, and particle size of 123 nanometers. A dihydropyridine function was then added to the resin to form resin 3340-83 by combining 300 parts by weight of resin 3340-082 with 0.79 part by weight of propionaldehyde. The mixture was sealed in a container and placed in an oven at 40° C. for a period of 24 hours, thereby forming resin 3340-083. A series of coating solutions were prepared as described below in Table 19. Coating solution 164Q is the only one prepared in accordance with the present invention in that it includes elements from groups IVB and VB. Coating solutions 164R and 164S are missing the group IVB or VB elements respectively. Each coating solution was then applied to either HDG or Galvalume (Gal) panels at a coating density of approximately 200 milligrams per square foot (200 milligrams per 929.03 centimeters) and dried to a peak metal temperature of 93° C. Multiple panels of each condition were then tested in the NSS test as described above and the average results for multiples at each time point and condition are reported below in Table 20.

TABLE 19

| Component | 164Q | 164R | 164S |
|---|---|---|---|
| DI Water | 62.85 | 83.95 | 63.35 |
| Bacote 20 | 24.0 | 0.0 | 24.0 |
| (NH₄)₂CO₃ | 0.0 | 2.9 | 0.0 |
| V₂O₅ | 0.5 | 0.5 | 0.0 |
| Resin 3340-083 | 12.15 | 12.15 | 12.15 |
| Cysteine | 0.5 | 0.5 | 0.5 |

TABLE 20

| Time | | | | | | |
|---|---|---|---|---|---|---|
| hours | 164Q | 164R | 164S | 164Q | 164R | 164S |
| (NSS) | Gal | Gal | Gal | HDG | HDG | HDG |
| 24 | 0 | 11.0 | 3.0 | 0.0 | 33.3 | 1.0 |
| 48 | 0 | 15.3 | 4.3 | 0.0 | 69.0 | 3.0 |
| 72 | 0 | 50.0 | 12.0 | 0.0 | 83.3 | 3.0 |
| 96 | | | | 0.0 | | 3.0 |
| 168 | 1.0 | | 25.0 | 0.3 | | 4.3 |
| 336 | 9.0 | | | 3.0 | | 50.0 |
| 504 | 10.0 | | | 10.0 | | |
| 672 | 12.0 | | | 43.3 | | |
| 840 | 12.0 | | | 83.3 | | |

The results shown in Table 20 clearly demonstrate the benefit of both IVB and VB elements in combination. With only one of the elements present the coating solution minimal corrosion protection.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A corrosion protective coating composition for metal substrates comprising an aqueous conversion coating composition comprising from 1 to 7% by weight, based on the total weight of the conversion coating composition, of at least one element from group IVB of the Periodic Table and from 0.2 to 2.0% by weight, based on the total weight of the conversion coating composition, of at least one element from group VB of the Periodic Table, said conversion coating composition having a pH of from about 6 to 11.

2. The conversion coating composition as claimed in claim 1, wherein the group IVB element comprises titanium, zirconium, or a mixture thereof.

3. The conversion coating composition as claimed in claim 1, wherein the IVB element comprises an aqueous alkaline composition of the IVB element.

4. The conversion coating composition as claimed in claim 1, wherein the group VB element comprises vanadium.

5. The conversion coating composition as claimed in claim 4, further comprising a reducing agent for reducing vanadium.

6. The conversion coating composition as claimed in claim 5 wherein said reducing agent comprises cysteine, ascorbic acid, Sn²⁺, thiosuccinic acid, or a mixture thereof.

7. The conversion coating composition as claimed in claim 1 further comprising a resin that is soluble or dispersible in said coating composition and stable at an alkaline pH and wherein said resin is selected from the group consisting of an epoxy resin, a polyvinyl dichloride resin, an acrylic-based resin, a methacrylate-based resin, a styrene-based resin, a polyurethane, and a mixture thereof.

8. The conversion coating composition as claimed in claim 7 wherein said resin comprises a polyvinyl dichloride resin and said group IVB element comprises zirconium and said group VB element comprises vanadium.

9. The conversion coating composition as claimed in claim 7 wherein said resin comprises a mixture of a styrene-based resin and acrylic-based resin and said group IVB element comprises zirconium and said group VB element comprises vanadium.

10. The conversion coating composition as claimed in claim 9 wherein said resin further comprises a polyvinyl dichloride resin.

11. The conversion coating composition as claimed in claim 7 wherein said resin comprises a mixture of methacrylate-based, styrene-based, and acrylate-based resins and said group IVB element comprises zirconium and said group VB element comprises vanadium.

12. The conversion coating composition as claimed in claim 11 further comprising a reducing agent for reducing the vanadium.

13. The conversion coating composition as claimed in claim 1, wherein said coating composition has an alkaline pH.

14. A method of providing a corrosion protective coating to a metal substrate comprising the steps of:
a) providing a metal substrate;
b) providing an aqueous conversion coating composition comprising from 1 to 7% by weight, based on the total weight of the conversion coating composition, of at least one element from group IVB of the Periodic Table and from 0.2 to 2.0% by weight, based on the total weight of the conversion coating composition, of at least one element from group VB of the Periodic Table, the conversion coating composition having a pH of from about 6 to 11;
c) applying the conversion coating composition to the metal substrate and then drying the coating composition in place thereby providing a corrosion protective coating to the metal substrate.

15. A metal substrate coated with a coating composition comprising: an aqueous conversion coating composition comprising from 1 to 7% by weight, based on the total weight of the coating composition, of at least one element from group IVB of the Periodic Table and from 0.2 to 2.0% by weight, based on the total weight of the coating composition, of at least one element from group VB of the Periodic Table, said conversion coating composition having a pH of from about 6 to 11.
